(19) United States
(12) Patent Application Publication
(10) Pub. No.: US 2008/0159497 A1
(43) Pub. Date: Jul. 3, 2008

(54) SERVER CONTROL APPARATUS

(75) Inventor: HENG-CHEN KUO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/838,239

(22) Filed: Aug. 14, 2007

(30) Foreign Application Priority Data
Dec. 27, 2006 (CN) 200610201419.9

(51) Int. Cl. H04M 11/00

(52) U.S. Cl. 379/93.26

(57) ABSTRACT

A server control apparatus includes an MCU, a DTMF receiver, and a voice chip. The voice chip saves a plurality of voice elements, and the MCU saves a plurality of voice messages each including a plurality of voice elements and play time of the voice elements, corresponding to status information of the server. The DTMF receiver transforms DTMF signals from a telephone to control signals and sends the control signals to the MCU, the MCU controls the server according to the control signals and receives status signals of the server. When the MCU receives one of the status signals of the server, the MCU outputs a corresponding voice message to the voice chip, and then the voice chip reads voice elements thereof according to the voice message and outputs them to the telephone, and then the telephone plays the voice message to indicate the status information of the server.

### BACKGROUND

1. Field of the Invention

The present invention relates to server control apparatuses, and particularly to a server control apparatus which controls a server via telephony.

2. Description of Related Art

There are many kinds of servers, such as application servers, communication servers, database servers, web servers, etc. When network of a server goes down, users can use a dedicated telephone to communicate with the server to receive status information of the server and to control the server. The conventional control methods require users to press keys of the telephone to receive the status information and send control signals. However, the status information of the server is received in the form of tones, so that users need to remember how various tones have been defined to recognize the status information of the server, which is very difficult and can easily lead to mistakes.

What is desired, therefore, is to provide a server control apparatus which can decipher status information tones of a server via a telephone and reveal the status information in a medium more user friendly.

### SUMMARY

An embodiment of a server control apparatus includes an MCU, a DTMF receiver, and a voice chip. The voice chip saves a plurality of voice elements, and the MCU saves a plurality of voice messages each including a plurality of voice elements and play time of the voice elements, corresponding to status information of the server. The DTMF receiver transforms DTMF signals from a telephone to control signals and sends the control signals to the MCU, the MCU controls the server according to the control signals and receives status signals of the server. When the MCU receives one of the status signals of the server, the MCU outputs a corresponding voice message to the voice chip, and then the voice chip reads voice elements thereof according to the voice message and outputs them to the telephone, and then the telephone plays the voice message to indicate the status information of the server.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is a circuit diagram of a server control apparatus in accordance with an embodiment of the present invention, together with a telephone and a server;

FIG. 2 is a data table of a memory of a voice chip of FIG. 1; and

FIG. 3 is a data table of an MCU of FIG. 1.

### DETAILED DESCRIPTION

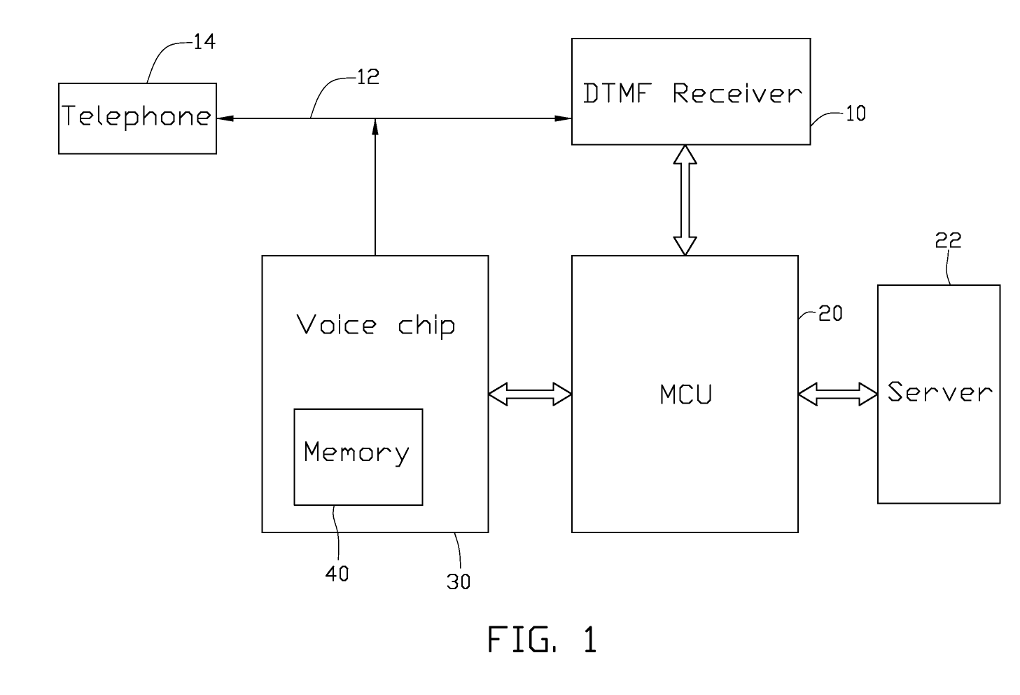

Referring to FIG. 1, a server control apparatus in accordance with an embodiment of the present invention includes a dual tone multi-frequency (DTMF) receiver 10, a micro control unit (MCU) 20, and a voice chip 30. The DTMF receiver 10 is electrically connected to a dedicated telephone 14 via a telephone line 12, and connected to the MCU 20 via data pins of the DTMF receiver 10. The MCU 20 is electrically connected to the voice chip 30 via selecting pins of the voice chip 30. The voice chip 30 is electrically connected to the telephone 14 via an output pin of the voice chip 30. The MCU 20 is electrically connected to a server 22.

When network of the server 22 is broken so that users can not control the server 22 via network, the users use the server control apparatus controls the server 22 via the telephone 14. The users presses keys of the telephone 14 to generate DTMF signals, the DTMF receiver 10 receives DTMF signals from the telephone 14 via the telephone line 12, and then transforms the DTMF signals to control signals to the MCU 20. The MCU 20 controls the server 22 according to the control signals and receives status signals of the server 22.

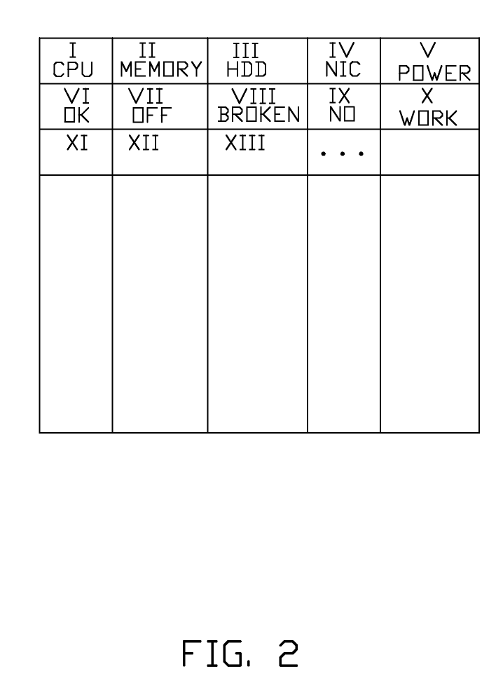

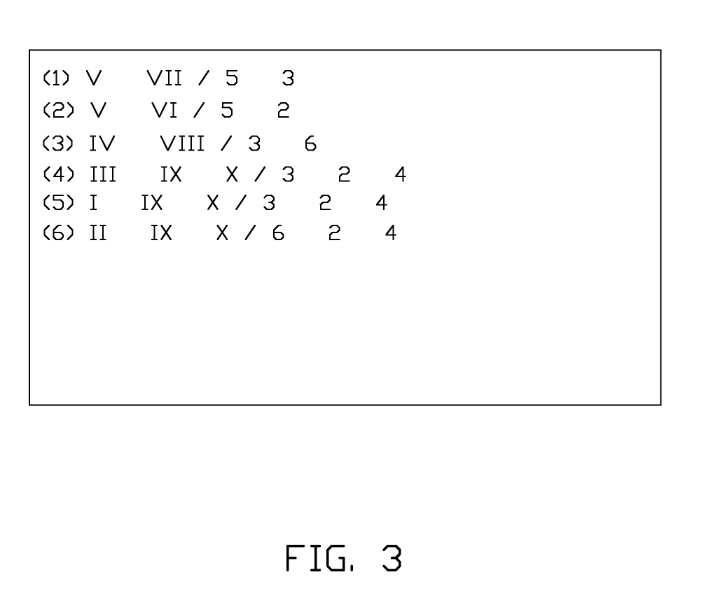

Referring also to FIGS. 2 and 3, a data table of a memory 40 of the voice chip 30 and a data table of the MCU 20 are shown. The memory 40 of the voice chip 30 saves a plurality of voice elements (I, II, III . . . depicted in FIG. 2), which can be used in different combinations to form a plurality of voice messages ((1), (2), (3), (4), (5), (6) shown in FIG. 3). In this embodiment, the voice elements are some words (such as CPU corresponding to the voice element I). The MCU 20 saves the voice messages each comprise a plurality of voice elements and play time (such as “5” denotes 0.5 second shown in FIG. 3) of the voice elements corresponding to the status information of the server 22. When the MCU 20 receives a status signal of the server 22 such as a network interface card (NIC) is broken, the MCU 20 outputs a corresponding voice message, such as (3) including IV, VIII respectively playing 0.3 second and 0.6 second shown in FIG. 3, to the voice chip 30, and then the voice chip 30 reads voice elements from the memory 40 according to the voice message, such as ‘NIC, BROKEN’ and outputs them to the telephone 14 via the telephone line 12. And then the telephone 14 plays the voice message via a speaker of the telephone 14, so that users can know the current status information of the server 22. In other embodiments, the voice elements of the memory 40 of the voice chip 30 and the voice messages of the MCU 20 can be changed according to need.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A server control apparatus configured for controlling a server via a dedicated telephone, comprising:
a micro control unit (MCU) connected to the server;
a dual tone multi-frequency (DTMF) receiver connected to the telephone and the MCU and configured for transforming DTMF signals from the telephone to control signals to the MCU such that the MCU controls the server according to the control signals and receives status signals of the server; and
a voice chip connected to the telephone and the MCU, wherein the voice chip saves a plurality of voice elements, the MCU saves a plurality of voice messages each comprises a plurality of voice elements and play time of the voice elements corresponding to status information of the server, when the MCU receives one of the status signals of the server, the MCU outputs a corresponding voice message to the voice chip, then the voice chip reads voice elements thereof according to the voice message and outputs them to the telephone, and then the telephone plays the voice message to indicate the status information of the server.

2. The server control apparatus as claimed in claim 1, wherein the voice elements are words.

3. The server control apparatus as claimed in claim 1, wherein the voice chip comprises a memory for saving the voice elements of the voice chip.

4. A server control apparatus configured for controlling a server, comprising:
a telephone configured for inputting a request for receiving status information of the server;
a DTMF receiver connected to the telephone via a telephone line to receive DTMF signals from the telephone in response to the request, and decoding the DTMF signals;
a micro control unit (MCU) connected to the DTMF receiver to convert the decoded DTMF signals to control signals, and sending the control signals to the server, the MCU storing a plurality of voice messages corresponding to different status of the server, the MCU capable of receiving a status signal from the server, and sending out a corresponding voice message; and
a voice chip connected to the MCU to receive said voice message, and outputting a series of voice elements accompanying time each voice element plays to the telephone, so that a speech directly representing the status information of the server is sounded.
